(19) United States
(12) Patent Application Publication
(10) Pub. No.: US 2013/0212039 A1
(43) Pub. Date: Aug. 15, 2013

(54) REVIEW TIMELINE FOR OWNERSHIP LIFECYCLE EXPERIENCE

(71) Applicants: Erik J. Burckart, Raleigh, NC (US); Michael P. Etgen, Cary, NC (US); Andrew Ivory, Wake Forest, NC (US)

(72) Inventors: Erik J. Burckart, Raleigh, NC (US); Michael P. Etgen, Cary, NC (US); Andrew Ivory, Wake Forest, NC (US)

(73) Assignee: INTERNATIONAL BUSINESS MACHINES CORPORATION, Armonk, NY (US)

(21) Appl. No.: 13/396,467

(22) Filed: Feb. 14, 2012

(51) Int. Cl. G06Q 30/02

(52) U.S. Cl. 705/347

(57) ABSTRACT

A consumer review system, including: a review interface presented on a display device; and a timeline in the review interface, wherein the timeline includes an aggregate set of user reviews corresponding to a product or a service, wherein the review interface is configured to organize the user reviews in the timeline by event date according to a lifecycle of the product or the service for each user.

### BACKGROUND

The shopping experience has changed dramatically with the increase of online purchases. In addition, the amount of information provided online for products and services has increased the ability of users engaged in the shopping experience to acquire knowledge and opinions about products or services from a large variety of sources.

Particularly, product or service ratings/reviews provide valuable information for consumers during the shopping experience. Users may rely partially or heavily on reviews or ratings from other users when making a product purchase or enlisting a service. The reviews may provide insight into problems encountered by other users for a given product or service or aspects of the product or service that users enjoyed. The user reviews may enhance the shopping experience by providing more information regarding the product or service.

### SUMMARY

Embodiments of a system are described. In one embodiment, the system is a consumer review system. The system includes: a review interface presented on a display device; and a timeline in the review interface, wherein the timeline includes an aggregate set of user reviews corresponding to a product or a service, wherein the review interface is configured to organize the user reviews in the timeline by event date according to a lifecycle of the product or the service for each user. Other embodiments of a method and a computer program product are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a consumer review system.

FIG. 2 depicts a schematic diagram of one embodiment of a review dialog.

FIG. 3 depicts a schematic diagram of one embodiment of the review interface of FIG. 1.

FIG. 4 depicts a schematic diagram of one embodiment of the review interface of FIG. 1.

FIG. 5 depicts a schematic diagram of one embodiment of the review interface of FIG. 1.

FIG. 6 depicts a schematic diagram of one embodiment of a ratings diagram.

FIG. 7 depicts a schematic diagram of one embodiment of a ratings diagram.

FIG. 8 depicts a flowchart diagram of one embodiment of a method for managing consumer reviews.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for managing consumer reviews in a review interface. Specifically, the system provides a timeline for displaying user reviews in a timeline of the review interface to allow consumers to view user reviews/ratings in an order based on an event date for each of the user reviews. In some embodiments, the user reviews may be displayed relative to a purchase date of the product or service. The system and method described herein may provide a consumer review interface that gives consumers a better idea of how a product or service may perform throughout the customer ownership lifecycle experience.

Many conventional systems make it possible to provide ratings and reviews on several different dimensions that give consumers information relating to various aspects of the product or service. However, the reviews and ratings are captured and displayed at a single point in time in the ownership lifecycle of that customer. For example, some customers may review the product the first day after using it, while another may wait for a month or more to review the product. A user's review/rating may change over the ownership lifecycle, and often does change in both large and small ways as a result of their use or experience in different circumstances. Because user reviews/ratings may change, users often attempt to provide ownership lifecycle type of information in their reviews (e.g., how long they have owned a particular product and how they have liked it so far). Some conventional systems allow users to edit or comment on their own previous reviews to add additional information in an attempt to provide more “lifecycle” information in their reviews. However, this is insufficient for supporting or representing a full customer ownership lifecycle experience.

The ratings and reviews systems do not support the capability for an individual reviewer to capture the users' full experiences over the full lifecycle of the product, or over a long term period of time, without going to a lot of work finding each review in a collective set of reviews that span the ownership lifecycle for any given user. Even if a reviewer is able to find the user reviews over the ownership lifecycle of a particular user, the generally text-based representation used by conventional ratings/reviews systems make it difficult to understand how the user's experiences plot against the lifecycle. Consequently, a system that displays user reviews for a consumer lifecycle experience provides an interface that allows consumers to easily view user reviews and ratings relative to the ownership/service time, which may provide valuable insight to a consumer as to how a product performs or how useful a service may be over a period of time.

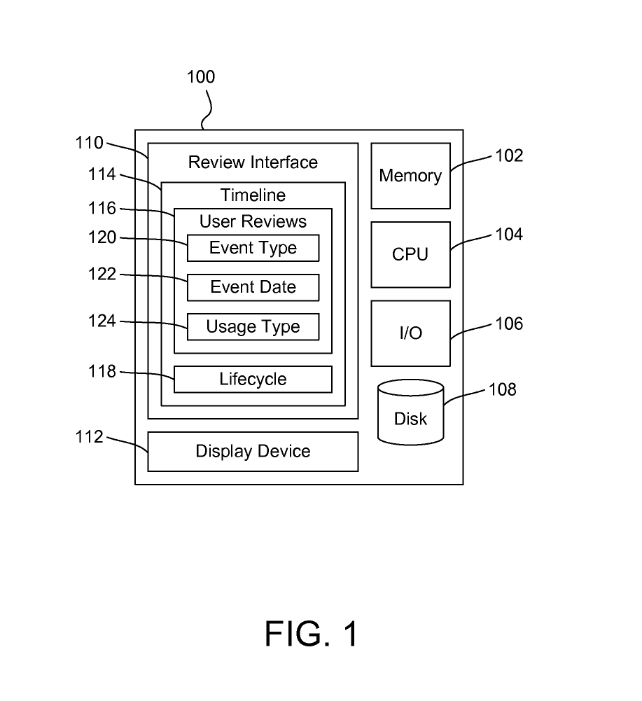

FIG. 1 depicts a schematic diagram of one embodiment of a consumer review system. The depicted consumer review system 100 includes various components, described in more detail below, that are capable of performing the functions and operations described herein. In one embodiment, at least some of the components of the consumer review system 100 are implemented in a computer system. For example, the functionality of one or more components of the consumer review system 100 may be implemented by computer program instructions stored on a computer memory device 102 and executed by a processing device 104 such as a CPU. The consumer review system 100 may include other components, such as a disk storage drive 108, input/output devices 106, a review interface 110, and a display device 112. Some or all of the components of the consumer review system 100 may be stored on a single computing device or on a network of computing devices, including a wireless communication network. The consumer review system 100 may include more or fewer components or subsystems than those depicted herein. In some embodiments, the consumer review system 100 may be used to implement the methods described herein as depicted in FIG. 8.

In one embodiment, the review interface 110 is a user interface for display on a display device 112 that allows a user to interact with the consumer review system 100. The review interface 110 may be integrated in a webpage, an application, or any other component on a computing device to allow the user to create reviews/ratings or to view user reviews 116 or ratings created by other users. For example, online stores that sell products and services may be able to implement the consumer review system 100 to provide a more usable and understandable view of product and service ownership to their prospective customers. The reduced complexity, improved context, and increased efficiency in interpreting a user's own ratings and reviews, as well as other customers' ratings and reviews, may then lead to faster purchase decision cycles and improved buyer experience.

In one embodiment, the user reviews 116 are displayed in a longitudinal fashion based on a customer ownership lifecycle experience (COLE) model for users of a product or service so that other consumers may be better informed about how the customer experience may change or be affected over time. The COLE model presents ratings and reviews that a consumer may use to review their experience for all aspects of ownership of a product or time span of a service—such as product setup, active use situations, customer service interactions, or any other event within the lifecycle of the product or service.

The review interface 110 includes a timeline 114 for displaying an aggregate set of user reviews 116. In various embodiments, the user reviews 116 may include written reviews, ratings, and categorizations, among others. The user reviews 116 may be represented with a plotted point, or “incident”, in the timeline 114. A rating, review text, or images/videos may be associated with the incident. In on embodiment, a snapshot of the user reviews 116 may be displayed on the timeline 114 for each incident to allow a reviewer to quickly get an idea for the reviews displayed in the timeline 114.

In one embodiment, the user reviews 116 may be displayed according to an event type 120—for example, a purchase date, passage of a certain amount of time since the purchase date, ease of use, customer support call, or some other event regarding the product or service. The user reviews 116 may also be associated with and/or display an event date 122 on the timeline 114. In some embodiments, the event date 122 displayed in the timeline 114 is calculated relative to the start date of a lifecycle 118 for a particular user. The lifecycle 118 may span any amount of time during an ownership period of a particular customer. In some embodiments, the lifecycle 118 spans from the purchase date through a current date or through a sale or termination date of the product or service. In some embodiments, the review interface 110 may classify the user reviews 116 by event type 120 and display the different event types 120 using different graphical indicators on the timeline 114.

In some embodiments, the review interface 110 may display multiple timelines 114 corresponding to various usage types 124 of the product or service. For example, one timeline 114 may correspond to a commercial usage of a particular product, and a second timeline 114 may correspond to a private or recreational usage of the product.

In some embodiments, the review interface 110 may be directly manipulated to move forward or backward in the timeline 114. Zoom controls may be used to zoom in or out on a particular incident or a range of time. This may allow a consumer to see more or fewer reviews as desired, or to focus on a specific period of time for the product or service.

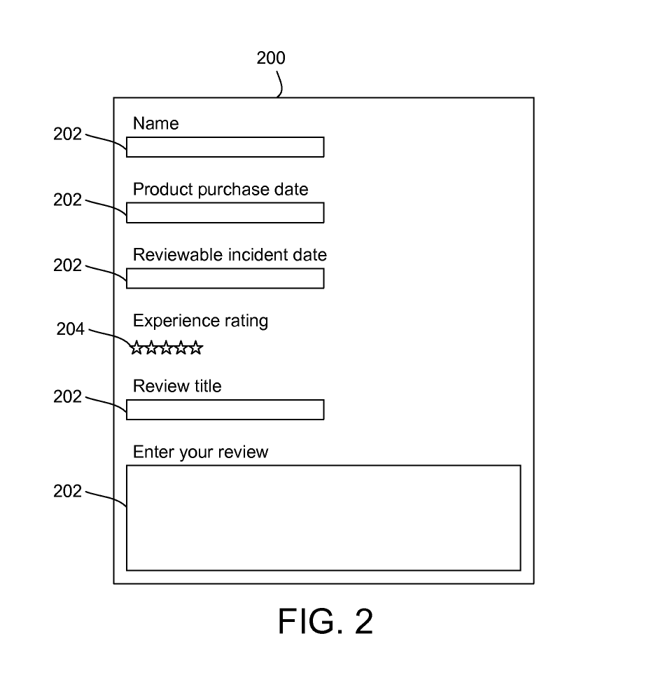

FIG. 2 depicts a schematic diagram of one embodiment of a review dialog 200. While the consumer review system 100 is described herein in conjunction with the review interface 110 of FIG. 2, the consumer review system 100 may be used in conjunction with any review interface 110.

In one embodiment, the review interface 110 includes a review dialog 200 that allows a user to input a review and/or a rating. The review dialog 200 may include various text fields 202 in which the user is able to input information corresponding to the product/service or to the user. Such information may include the user's name, the product/service purchase date, the reviewable incident date (the date in which the review is being entered), the review title, and a review field. The user may input the review in the review field. In one embodiment, the review dialog 200 includes an experience rating 204 in which the user may enter a review. The experience rating 204 may allow the user to select a star rating for the product/service; for example, the user may select a star rating to go along with a text review of the product/service.

Some or all of the information entered into the review dialog 200 may be viewable by other users when the user review 116 is plotted on the timeline 114. In some embodiments, some of the information entered into the review dialog 200 is not visible to anyone but the user who enters the information. This may help protect any confidential identification information that is entered into the review dialog 200. The identification information may be used by the consumer review system 100 to verify the identity of the user, but may not be necessary for display with the user review 116.

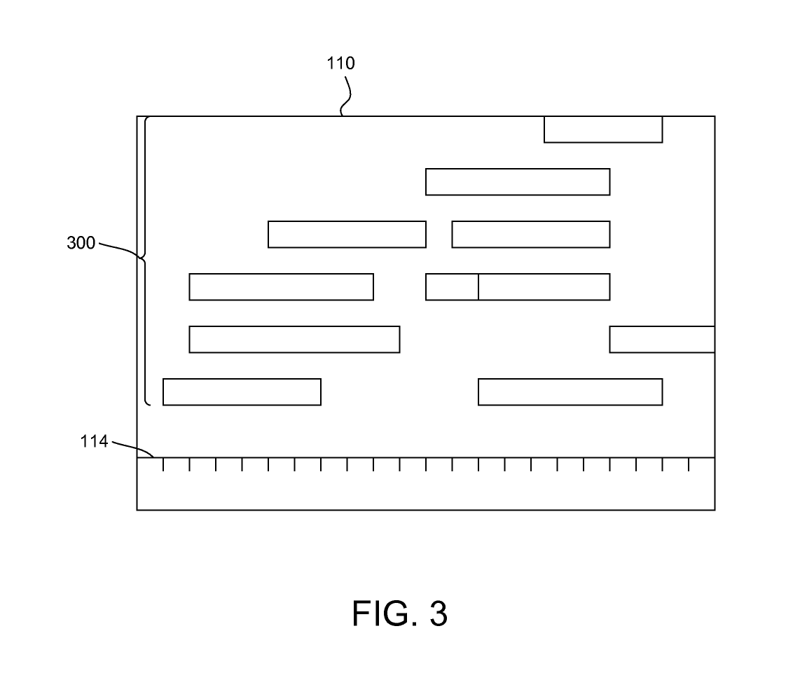

FIG. 3 depicts a schematic diagram of one embodiment of the review interface 110 of FIG. 1. While the consumer review system 100 is described herein in conjunction with the review interface 110 of FIG. 3, the consumer review system 100 may be used in conjunction with any review interface 110.

In one embodiment, the consumer review system 100 includes a timeline 114 that includes the user reviews 116 for a particular product or service. The timeline 114 may display the user reviews 116 in an organized manner that allows consumers to see the lifecycle 118 for one or more users. In one embodiment, the user reviews 116 are grouped by user and displayed in a chronological order. The user reviews 116 may be grouped by displaying all user reviews 116 for a given user on a single line parallel to the timeline scale, in some embodiments. In some embodiments, the user reviews 116 may overlap with each other. In some embodiments, the user reviews 116 for the given user may be displayed in a staggered manner along the timeline 114. In other embodiments, the user reviews 116 may be grouped and displayed in other ways. The timeline 114 may be displayed along any axis of the display device 112.

In one embodiment, snapshots 300 of the user reviews 116 are displayed in a default view of the timeline 114. The snapshots 300 may include the review title, the rating, a portion of the review text, or any of the information corresponding to the user review 116 that may be useful to consumers viewing the timeline 114. In one embodiment, the timeline 114 displays points corresponding to the user reviews 116 on the timeline 114 in the default view. The snapshots 300 for user reviews 116 may appear if the user rolls over the points in the timeline 114, for example. The user reviews 116 may be displayed on the timeline 114 in any way to allow the user to navigate the user reviews 116 and interpret the lifecycle experience for each user.

The review interface 110 may be configured to zoom in or out on any portion of the timeline 114, including any axis. The timeline 114 may scale accordingly, and the review interface 110 may maintain the timeline 114 on the display device 112 for any zoomed view, according to some embodiments.

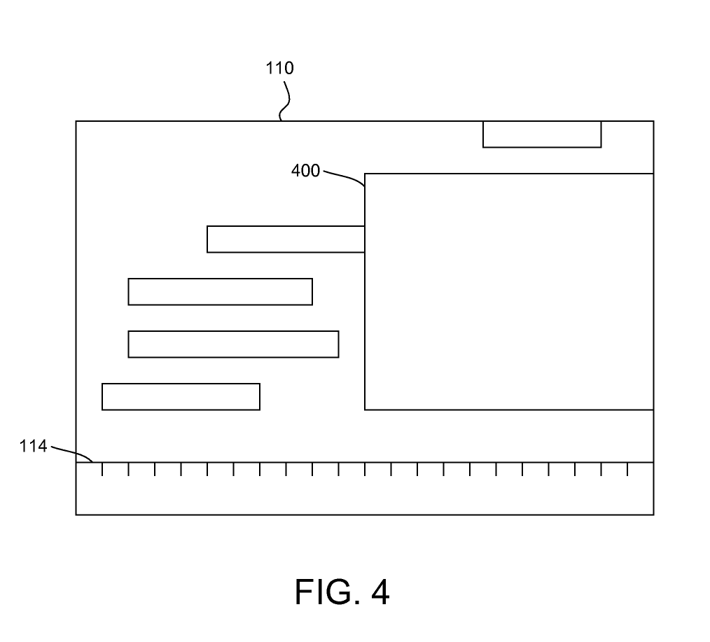

FIG. 4 depicts a schematic diagram of one embodiment of the review interface 110 of FIG. 1. While the consumer review system 100 is described herein in conjunction with the review interface 110 of FIG. 4, the consumer review system 100 may be used in conjunction with any review interface 110.

In one embodiment, the review interface 110 provides a way for consumers to expand the user reviews 116 on the timeline 114 to a detailed view 400. The user reviews 116 may be expanded in response to various inputs from the consumer, depending on the implementation. For example, a user review 116 may expand in response to a mouse-over event on a point or snapshot 300 representing the user review 116. In another example, the user review 116 may expand in response to a mouse click on the point or snapshot 300 representing the user review 116. In other examples, the user reviews 116 may expand to a detailed view 400 in response to other types of input, or in other layouts of the timeline 114. In some embodiments, more than one user review 116 may be expanded to a detailed view 400 at a time. This may allow a consumer to easily compare reviews in the timeline 114. In some embodiments, the review interface 110 may also allow the user to select one or more reviews to focus on and alter the view or layout to display the selected user reviews 116 in a side-by-side comparison or other focused view.

In one embodiment, the detailed view 400 of the user review 116 displays some or all information entered by the user into the review dialog 200. The detailed view 400 may be displayed in a popup window or a pre-designated area of the review interface 110. When the text or data included in the detailed view 400 is too large to fit within the popup window, the popup window may be expandable or scrollable so that users are able to view all of the data in the user review 116. The popup window containing the detailed view 400 may be moved within the review interface 110 to allow the user to view plotted points or user reviews 116 on the timeline 114 in any portion of the review interface 110.

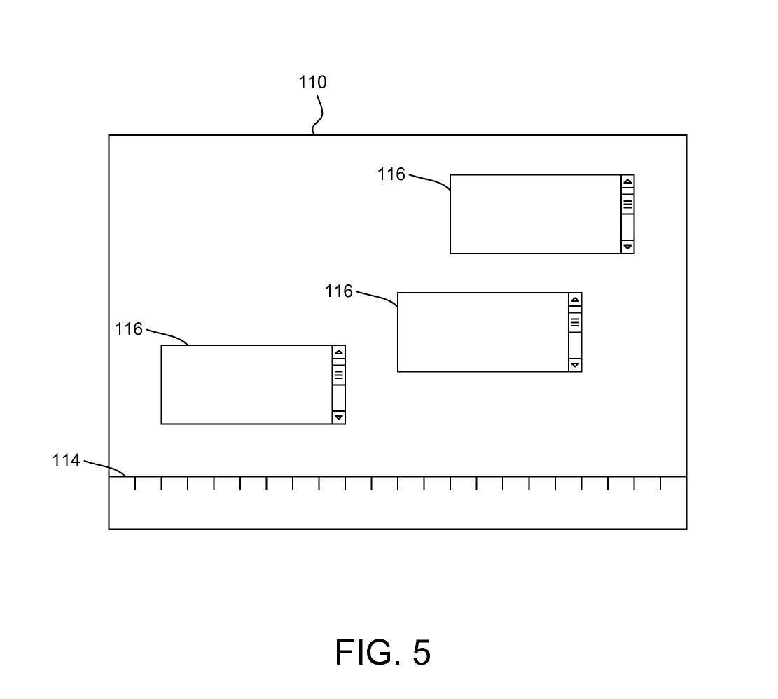

FIG. 5 depicts a schematic diagram of one embodiment of the review interface 110 of FIG. 1. While the consumer review system 100 is described herein in conjunction with the review interface 110 of FIG. 5, the consumer review system 100 may be used in conjunction with any review interface 110.

In one embodiment, the user reviews 116 may be filtered to display only the user reviews 116 corresponding to a particular user. The filtered user reviews 116 may be a full set of ratings and reviews in the lifecycle experience for the user, allowing consumers to view their own user reviews 116 or the user reviews 116 of other consumers. The layout of the user reviews 116 in the timeline 114 may be altered in response to filtering the user reviews 116 by a particular user. In one embodiment, the review interface 110 is zoomed to display all the user reviews 116 for the user when the filter is applied. In one embodiment, the review interface 110 is configured to display user reviews 116 for the lifecycle 118 of a selected group of users on the timeline 114, while removing the user reviews 116 of unselected users from the timeline 114. This may allow the consumer viewing the user reviews 116 to easily compare the lifecycles 118 for multiple users.

In one embodiment, when the user logs in to an account associated with the review interface 110, the user may choose to view all previous user reviews 116 for the user in the timeline 114. The previous user reviews 116 may help give the user a frame of reference for making any new reviews. The review interface 110 may display the date and time at which each user review 116 for the user was posted to the review interface 110. In some embodiments, the date and time are only displayed to the user who wrote the user review 116. When a user is adding ratings/review information to the consumer review system 100, the timeline 114 may be re-displayed to present real dates and times for ease of data entry. The date and time data may then be automatically converted to a time relative to the start time for the specified lifecycle 118. Consequently, a time reference may be displayed for the user reviews 116 of other users, where the time reference indicates a time relative to the lifecycle 118 of a particular user (for example, how much time has passed from the purchase date of the product until the user review 116 is posted), rather than a date at which the user review 116 was posted.

In one embodiment, the review interface 110 is configured to automatically detect a purchase date or start date corresponding to a user review 116 being entered. For example, for an initial review, the user may be required to indicate how long the user has owned the product or enter proof of purchase/delivery information into the review interface 110. In another example, the consumer review system 100 either includes or is in communication with another system that contains the purchase/delivery information, and is able to extract the information for the user based on a login identification system. The start date may then automatically be entered into the user review 116. The start date may alternatively correspond to an event type 120 other than a purchase date. In another embodiment, the user enters or chooses the start date manually.

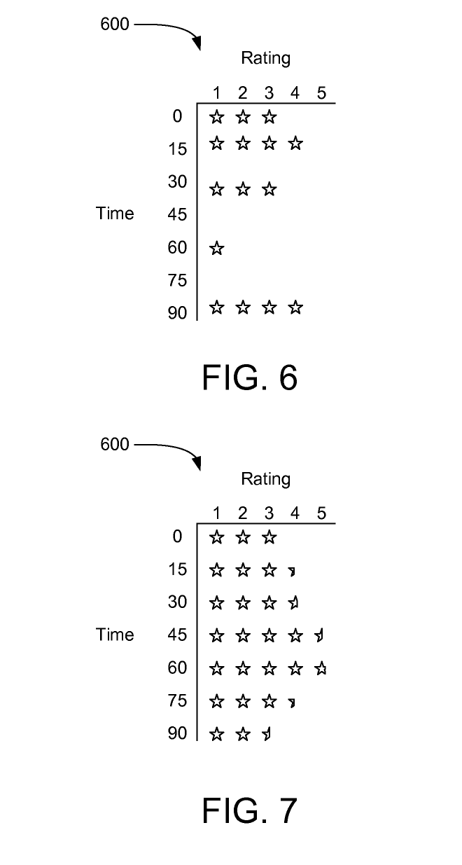

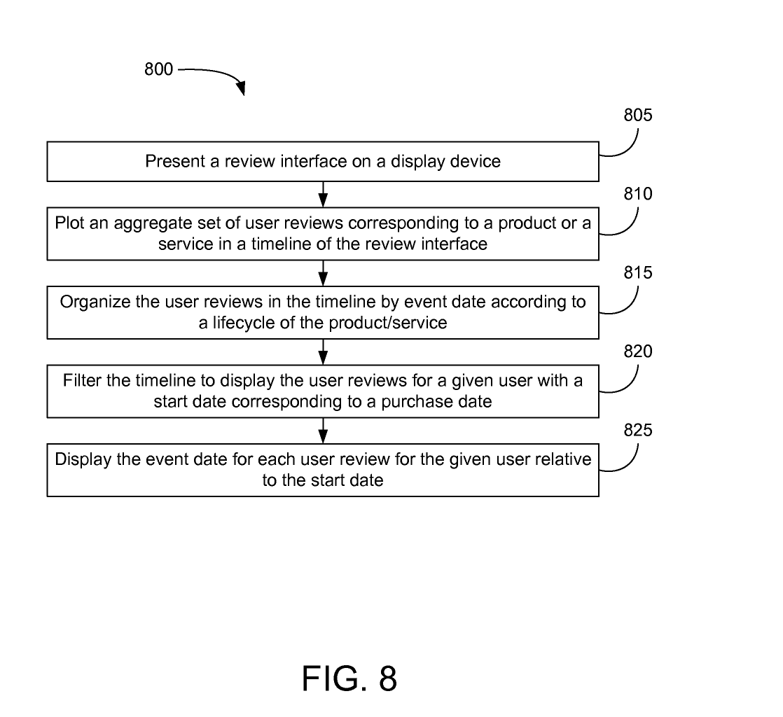

FIGS. 6 and 7 depict schematic diagrams of embodiments of a ratings diagram 600. While the consumer review system 100 is described herein in conjunction with the ratings diagram 600 of FIGS. 6 and 7, the consumer review system 100 may be used in conjunction with any ratings diagram 600.

In one embodiment of the ratings diagram 600, the ratings diagram 600 may display several ratings by a particular user for a product or service. The ratings diagram 600 may display all ratings for a particular user during the lifecycle 118 of the product/service for the user. The user reviews 116 may be input by the user at different intervals, such that when the ratings are displayed on the ratings diagram 600, spacing between the ratings may be proportionate to the time between the user ratings. Because a customer's experience and opinion of a product or service may change over time, the ratings diagram 600 may include different ratings for each user review 116 at different times during the lifecycle 118, as shown in FIG. 6. This may provide a visual model for easily viewing a particular customer's opinion of the product or service.

The review interface 110 may be configured to display a ratings diagram 600 with averaged ratings values for multiple users over a lifecycle 118 for each user. The ratings diagram 600 may display the average rating values at specific time intervals for all of the customers whose reviews correspond to the given timeline 114, as shown in FIG. 7. Because the user timeline 114 corresponds to lifecycles 118 for different users, the timelines 114 may begin and end on different dates. Consequently, determining the time of the user reviews 116 relative to the start date of the corresponding user's lifecycle 118 allows the consumer review system 100 to get an average rating to be displayed in the ratings diagram 600.

In some embodiments, the consumer viewing the user reviews 116 may customize various aspects of the ratings diagram 600, such as the time period shown, the number of reviews shown, the number of users for which reviews are shown, or other aspects of the ratings diagram 600.

FIG. 8 depicts a flowchart diagram of one embodiment of a method 800 for managing consumer reviews. Although the method 800 is described in conjunction with the consumer review system 100 of FIG. 1, embodiments of the method 800 may be implemented with other types of consumer review systems 100.

In one embodiment, the consumer review system 100 presents 805 a review interface 110 on a display device 112. The display device 112 may include any type of display device 112, such as a computer monitor or a mobile device. The consumer review system 100 is configured to plot 810 an aggregate set of user reviews 116 corresponding to a product or a service in a timeline 114 of the review interface 110. The system 100 organizes 815 the user reviews 116 in the timeline 114 by event date according to a lifecycle 118 of the product/service, which may allow the user reviews 116 from multiple users to be plotted on the timeline 114 for comparing of lifecycles 118. The lifecycles may be displayed on the timeline 114 according to actual start date or with aligned start dates and event dates 122 relative to the start dates, according to various embodiments.

The system 100 may be configured to filter 820 the timeline 114 to display the user reviews 116 for a given user with a start date corresponding to a purchase date of the product/service. The system 100 may display 825 the event date 122 for each user review 116 for the given user relative to the start date of that user's lifecycle 118.

In one embodiment, the system 100 classifies the user reviews 116 by event type 120. Each event type 120 may be displayed in the timeline 114 using a different graphical indicator. This may allow the event types 120 to be distinguished easily as a consumer looks at the timeline 114.

In one embodiment, the system 100 is configured to display a snapshot 300 of each user review 116 in a default view of the timeline 114. The user reviews 116 may be expanded to a detailed view 400 in response to a selection of one of the user reviews 116. The selected user review 116 may be expanded to display any amount of content depending on the implementation of the system 100.

In one embodiment, the system 100 is configured to enter an edit mode in response to a request to input a new review for a given user. In edit mode, the system 100 displays dates and times for previous user reviews 116 in the timeline 114 for the product/service for the given user. Displaying the real dates and times for the user reviews 116, rather than the time relative to the start date of the timeline 114, may provide a reference for the user to enter information into the new review. In one embodiment, the system 100 may automatically insert the start date for an initial review in response to identifying the given user.

In one embodiment, the system 100 displays a plurality of timelines 114 for the product/service. Each timeline 114 may correspond to a separate usage type 124 for the product/service. In various embodiments, the usage types 124 may be uses of the product or service that are major intended uses, such as commercial use or recreational use. This may allow other consumers to better map their potential usage pattern to the users who have reviewed the product or service.

An embodiment of a consumer review system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for managing consumer reviews.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

1. A computer program product, comprising:
a computer readable storage medium to store a computer readable program, wherein the computer readable program, when executed by a processor within a computer, causes the computer to perform operations for managing consumer reviews, the operations comprising:
presenting a review interface on a display device; and
plotting, for each user, an aggregate set of user reviews corresponding to a product or a service in a timeline of the review interface, wherein the aggregate set of user reviews for a user comprises a plurality of user reviews at different times for the product or the service; and
organizing the aggregate set of user reviews in the timeline by an event date of each of the plurality of user reviews according to a lifecycle of the product or the service for each user.

2. The computer program product of claim 1, wherein the computer readable program, when executed on the computer, causes the computer to perform additional operations, comprising:
classifying the user reviews by event type; and
displaying each event type in the timeline with a different graphical indicator.

3. The computer program product of claim 1, wherein the computer readable program, when executed on the computer, causes the computer to perform additional operations, comprising:
displaying a snapshot of each user review in a default view of the timeline; and
expanding a selected user review to a detailed view in response to a selection of one of the user reviews.

4. The computer program product of claim 1, wherein the computer readable program, when executed on the computer, causes the computer to perform additional operations, comprising:
filtering the timeline to display the user reviews corresponding to a given user, wherein the lifecycle comprises a start date corresponding to a purchase date for the product or the service for the given user; and
displaying the event date for each user review for the given user relative to the start date.

5. The computer program product of claim 1, wherein the computer readable program, when executed on the computer, causes the computer to perform additional operations, comprising:
entering an edit mode in response to a request to input a new review for a given user; and
displaying dates and times for previous user reviews in the timeline for the product or the service for the given user.

6. The computer program product of claim 5, wherein the computer readable program, when executed on the computer, causes the computer to perform additional operations, comprising:
automatically inserting the start date for an initial review in response to identifying the given user.

7. The computer program product of claim 1, wherein the computer readable program, when executed on the computer, causes the computer to perform additional operations, comprising:
displaying a plurality of timelines for the product or the service, wherein each timeline corresponds to a separate usage type for the product or the service.

8. A method for managing consumer reviews, comprising:
presenting a review interface on a display device; and
plotting, for each user, an aggregate set of user reviews corresponding to a product or a service in a timeline of the review interface, wherein the aggregate set of user reviews for a user comprises a plurality of user reviews at different times for the product or the service; and
organizing the aggregate set of user reviews in the timeline by an event date of each of the plurality of user reviews according to a lifecycle of the product or the service for each user.

9. The method of claim 8, further comprising:
classifying the user reviews by event type; and
displaying each event type in the timeline with a different graphical indicator.

10. The method of claim 8, further comprising:
displaying a snapshot of each user review in a default view of the timeline; and
expanding a selected user review to a detailed view in response to a selection of one of the user reviews.

11. The method of claim 8, further comprising:
filtering the timeline to display the user reviews corresponding to a given user, wherein the lifecycle comprises a start date corresponding to a purchase date for the product or the service for the given user; and
displaying the event date for each user review for the given user relative to the start date.

12. The method of claim 8, further comprising:
entering an edit mode in response to a request to input a new review for a given user; and
displaying dates and times for previous user reviews in the timeline for the product or the service for the given user.

13. The method of claim 12, further comprising:
automatically inserting the start date for an initial review in response to identifying the given user.

14. The method of claim 8, further comprising:
displaying a plurality of timelines for the product or the service, wherein each timeline corresponds to a separate usage type for the product or the service.

15. A consumer review system, comprising:
a display device configured to present a review interface; and
a timeline in the review interface, wherein the timeline comprises an aggregate set of user reviews corresponding to a product or a service, wherein the aggregate set of user reviews for a user comprises a plurality of user reviews at different times for the product or the service,
wherein the review interface is configured to organize the user reviews in the timeline by an event date of each of the plurality of user reviews according to a lifecycle of the product or the service for each user.

16. The system of claim 15, wherein the review interface is further configured to:
classify the user reviews by event type; and
display each event type in the timeline with a different graphical indicator.

17. The system of claim 15, wherein the review interface is further configured to:
display a snapshot of each user review in a default view of the timeline; and
expand a selected user review to a detailed view in response to a selection of one of the user reviews.

18. The system of claim 15, wherein the review interface is further configured to:
filter the timeline to display the user reviews corresponding to a given user, wherein the lifecycle comprises a start date corresponding to a purchase date for the product or the service for the given user; and
display the event date for each user review for the given user relative to the start date.

19. The system of claim 15, wherein the review interface is further configured to:
enter an edit mode in response to a request to input a new review for a given user; and
display dates and times for previous user reviews in the timeline for the product or the service for the given user.

20. The system of claim 15, wherein the review interface is further configured to:
display a plurality of timelines for the product or the service, wherein each timeline corresponds to a separate usage type for the product or the service.
